(19) United States
(12) Patent Application Publication
(10) Pub. No.: US 2007/0276687 A1
(43) Pub. Date: Nov. 29, 2007

(54) SHOELACE GREETING

(76) Inventor: Angel Casanova, Winston Salem, NC (US)

Correspondence Address: EDWIN TARVER, 16830 Ventura Blvd., SUITE 360, Encino, CA, 91436, US

(21) Appl. No.: 11/745,740

(22) Filed: May 8, 2007

Related U.S. Application Data
(60) Provisional application No. 60/799,204, filed on May 9, 2006.

(51) Int. Cl. G06Q 10/00; G06Q 30/00

(52) U.S. Cl. 705/1

(57) ABSTRACT

A shoelace with greeting messages imprinted on the surface. The greeting messages can be imprinted on either or both sides of the shoelace. In one embodiment, the greeting message includes two parts, namely, a first part similar to messages on the outside of a normal greeting card and a second part similar to messages on the inside of a normal greeting card.

### CROSS-REFERENCE TO RELATED APPLICATION

This applications claims benefit of provisional application No. 60/799,204 filed on May 9, 2006.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to articles with greeting messages, and more particularly to a shoelace with imprinted greeting messages.

Several shoelaces and similar articles, which include a greeting message or any other message or image have been developed in the art. U.S. Pat. No. 5,633,058 to Hoffer discloses a tape that is secured to a container or other object which when removed causes the display of a message on one side of the surface which was formerly not visible, such as notification that the object has been tampered with, the tape being provided on one surface with an adhesive layer so that it can be attached to the object and provided on its opposite surface with a release layer. However, unlike the present invention, this prior art is a tape and involves removal of the tape to display a message.

U.S. Pub. No. 20050055811 to Cheng discloses a shoelace, which includes a retaining end molded at both ends of the shoelace. Both the ends are made of silica gel mixed with materials like gold dust, colorful eye catching effects to boost its competitive power in the market. Although this prior art device displays colorful objects only at the ends of shoelace, it also lacks the display of specific messages or the like.

U.S. Pat. No. 5,195,783 Lavoie discloses an identification device which includes a shoelace, near the center of which is affixed a flexible strip, made from textile or plastic that is adapted to be wrapped about the shoelace and retained in that position. It contains information such as name, address, blood type, medical facts of concern or the like. The distinguishing indicia at the center of the shoelace is to notify information to the interested personnel such as police, medical personnel or the like. However, the actual method of displaying a greeting message in the present invention is different from this device.

### SUMMARY

The present invention generally relates to articles with greeting messages and more particularly to a shoelace with imprinted greeting messages. The greeting messages are imprinted on one side of the shoelace. According to the present invention, the greeting message includes two parts, namely, a first part similar to messages on the outside of a normal greeting card and a second part similar to messages on the inside of a normal greeting card. The first part of the greeting message is imprinted on the left end portion of the shoelace and the second part of the greeting message is imprinted on the right end portion of the shoelace.

### BRIEF DESCRIPTION OF THE FIGURES

FIG. 1 shows the shoelace with messages imprinted on one of its sides in accordance with the present invention.

FIG. 2 shows a second side of the shoelace without the imprinted messages in accordance with the present invention.

### FIGURES—REFERENCE NUMERALS

| | |
|---|---|
| 10 | Shoelace |
| 12 | Left End Portion |
| 14 | Right End Portion |
| 16 | Central Portion |
| 18 | Tip |

### DETAILED DESCRIPTION

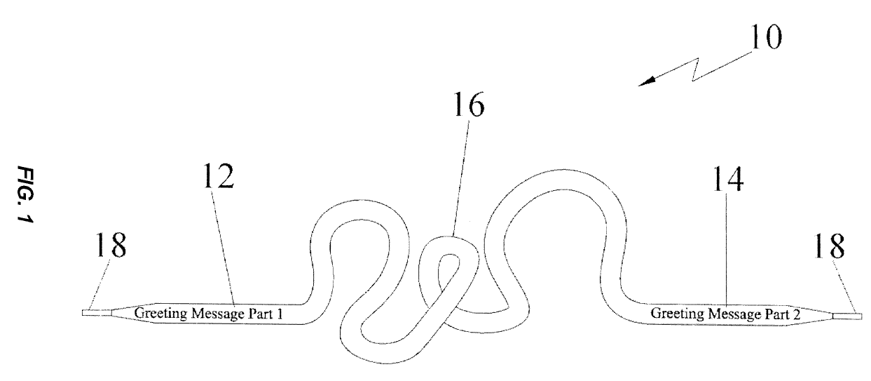

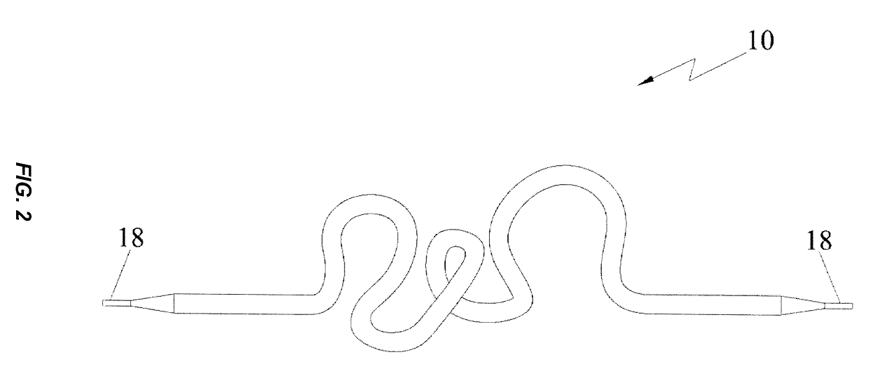

Referring to the drawings, a preferred embodiment of the present invention is illustrated in FIGS. 1 and 2. The present invention is a shoelace 10 with imprinted greeting messages.

Referring to FIGS. 1 and 2, a shoelace 10 is an elongated strip with two of its free ends including substantially rigid tips 18. For explanatory purposes, the elongated strip portion is divided into a left end portion 12, a right end portion 14, and a central portion 16. Generally, shoelaces are flat, and therefore include two opposite sides, front and back. According to the present invention, the front side of the shoelace 10 is imprinted with greeting messages, while the backside of the shoelace 10 is left blank, as seen in FIG. 2.

In one embodiment, a greeting message that is to be imprinted on the front side of the shoelace is divided into two parts, namely, first and second. The first part of the greeting message is similar to messages on the outside of a normal greeting card and the second part is similar to messages on the inside of a normal greeting card. The first part of the greeting message is printed on the left end portion 12 of the shoelace 10 and the second part on the right end portion 14 of the shoelace 10. The central portion 16 of the shoelace 10 is left blank. The shoelace 10 may further include graphics to enhance the greeting messages.

In an alternate embodiment of the present invention, the greetings extend from the tips of the shoelace inward. In a further embodiment of the present invention, the messages extend no further than four inches from the tips. In yet another embodiment, the messages extend no further than six inches from the tips.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An information displaying device for use with articles comprising garments and shoes, comprising:
a flexible strip bearing information that is arranged such that the information is visible after the strip is installed on the articles, the information is divided into at least two parts that are spaced apart on the strip.

2. The device of claim 1, wherein the information is divided into a first part on one end portion of the strip and a second part on the other end portion of the strip.

3. The device of claim 2, wherein the portion between the first and second part is blank.

4. The device of claim 2, wherein the strip is a shoe lace and the first and second parts are disposed such that they are visible after the shoe lace is installed on a shoe.

5. The device of claim 4, wherein the first and second parts are on one surface of the shoe lace.

6. The device of claim 4, wherein the first part comprises messages that are similar to the messages on the outside of a normal greeting card and the second part comprises messages that are similar to the messages on the inside of a normal greeting card.

7. The device of claim 6, wherein the first part is on the left end portion of the shoelace and the second part on the right end portion of the shoelace.

8. The device of claim 1, wherein the at least two parts comprise messages and graphics.

9. The device of claim 1, wherein the information is imprinted on the strip.

10. The device of claim 1, wherein the information is imprinted on a space measuring four inches or less, extending inward from each tip of the shoelace.

11. The device of claim 1, wherein the information is imprinted on a space measuring six inches or less, extending inward from each tip of the shoelace.
